(19) United States
(12) Patent Application Publication
(10) Pub. No.: US 2022/0036633 A1
(43) Pub. Date: Feb. 3, 2022

(54) SHADER FOR REDUCING MYOPIAGENIC EFFECT OF GRAPHICS RENDERED FOR ELECTRONIC DISPLAY

(71) Applicant: Visu, Inc., Palo Alto, CA (US)

(72) Inventor: David William Olsen, Fremont, CA (US)

(21) Appl. No.: 17/396,012

(22) Filed: Aug. 6, 2021

Related U.S. Application Data
(63) Continuation of application No. PCT/US2020/017190, filed on Feb. 7, 2020.
(60) Provisional application No. 62/802,649, filed on Feb. 7, 2019.

(51) Int. Cl. G06T 15/00; G06T 15/04

(52) U.S. Cl. CPC G06T 15/005; G06T 15/04

(57) ABSTRACT

The invention features a system, including a graphics processing unit (GPU) and a memory storing instructions that when executed cause the GPU to: (i) receive, by a fragment shader executed on the GPU, rasterized data of a fragment of an image frame; (ii) determine, by the fragment shader executed on the GPU, an initial color for each pixel of the fragment; (iii) compute, by the fragment shader executed on the GPU, a relative level of stimulation of cones in a viewer's eye for each pixel of the fragment; (iv) compute, by the fragment shader executed on the GPU, a myopia-corrected color for each pixel of the fragment having a relative level of stimulation exceeding a threshold level, and (v) output, from the fragment shader executed on the GPU, the myopia-corrected pixel data for the fragment.

### CROSS-REFERENCE TO RELATED APPLICATIONS

This application is a continuation of PCT Application No. PCT/US2020/017190, filed on Feb. 7, 2020, which claims priority to Provisional Application No. 62/802,649, filed on Feb. 7, 2019, and each application is hereby incorporated by reference in its entirety.

### BACKGROUND

A graphics processing unit (GPU) is a dedicated graphics rendering device used to generate computerized graphics for display on a display device. GPUs are built with a highly-parallel structure that provides more efficient processing than typical, general purpose central processing units (CPUs) for a range of complex algorithms. For example, the complex algorithms may correspond to representations of three-dimensional computerized graphics. In such a case, a GPU can implement a number of primitive graphics operations to create three-dimensional images for display on a display device more quickly than using a CPU to draw the image for display on the display device.

A typical GPU receives an image geometry and uses a pipeline approach to generate graphics which can be output, for example, for display on a display device. A typical graphics pipeline includes a number of stages which operate in parallel, with the output from one stage possibly being used at another stage in the pipeline. For example, a typical graphics pipeline comprises vertex shader, primitive assembly, viewport transformation, primitive setup, rasterization, hidden primitive and pixel rejection, attribute setup, attribute interpolation and fragment shader stages.

A vertex shader is applied to the image geometry for an image and generates vertex coordinates and attributes of vertices within the image geometry. Vertex attributes include, for example, color, normal, and texture coordinates associated with a vertex. Primitive assembly forms primitives, e.g., point, line, and triangle primitives, from the vertices based on the image geometry. Formed primitives can be transformed from one space to another using a transformation, e.g., a viewport transformation which transforms primitives from a normalized device space to a screen space. Primitive setup can be used to determine a primitive's area, edge coefficients, and perform occlusion culling (e.g., backface culling), and 3-D clipping operations.

Rasterization converts primitives into pixels based on the XY coordinates of vertices within the primitives and the number of pixels included in the primitives. Hidden primitive and pixel rejection use the z coordinate of the primitives and/or pixels to determine and reject those primitives and pixels determined to be hidden (e.g., a primitive or pixel located behind another primitive or pixel in the image frame, a transparent primitive or pixel). Attribute setup determines attribute gradients, e.g., a difference between the attribute value at a first pixel and the attribute value at a second pixel within a primitive moving in either a horizontal (X) direction or a vertical (Y) direction, for attributes associated with pixels within a primitive. Attribute interpolation interpolates the attributes over the pixels within a primitive based on the determined attribute gradient values. Interpolated attribute values are sent to the fragment shader for pixel rendering. Results of the fragment shader can be output to a post-processing block and a frame buffer for presentation of the processed image on the display device.

When viewing images on an electronic display, and more generally, humans perceive color in response to signals from photoreceptor cells called cone cells, or simply cones. Cones are present throughout the central and peripheral retina, being most densely packed in the fovea centralis, a 0.3 mm diameter rod-free area in the central macula. Moving away from the fovea centralis, cones reduce in number towards the periphery of the retina. There are about six to seven million cones in a human eye.

Humans normally have three types of cones, each having a response curve peaking at a different wavelength in the visible light spectrum. The first type of cone responds the most to light of long wavelengths, peaking at about 560 nm, and is designated L for long. The second type responds the most to light of medium-wavelength, peaking at 530 nm, and is abbreviated M for medium. The third type responds the most to short-wavelength light, peaking at 420 nm, and is designated S for short, shown as curve C. The three types have typical peak wavelengths near 564-580 nm, 534-545 nm, and 420-440 nm, respectively; the peak and absorption spectrum varies among individuals. The difference in the signals received from the three cone types allows the brain to perceive a continuous range of colors, through the opponent process of color vision.

In general, the relative number of each cone type can vary. Whereas S-cones usually represent between 5-7% of total cones, the ratio of L and M cones can vary widely among individuals, from as low as 5% L/95% M to as high as 95% L/5% M. The ratio of L and M cones also can vary, on average, between members of difference races, with Asians believed to average close to 50/50 L:M and Caucasians believed to average close to 63% L cones (see, for example, U.S. Pat. No. 8,951,729). Color vision disorders can also impact the proportion of L and M cones; for example, protonopes have 0% L cone functionality—either due to absence or damage; likewise deuteranopes have 0% M cone functionality—either due to absence or damage. Referring to FIG. 1A, cones are generally arranged in a mosaic on the retina. In this example, L and M cones are distributed in approximately equal numbers, with fewer S cones. Accordingly, when viewing an image on an electronic display, the response of the human eye to a particular pixel will depend on the color of that pixel and where on the retina the pixel is imaged.

### SUMMARY

Exposure to outdoor sunlight is not generally considered a risk factor for myopia (see, for example Jones, L. A. et al. Invest. Ophthalmol. Vis. Sci. 48, 3524-3532 (2007)). Sunlight is considered an equal energy (EE) illuminant because it does not trigger the opponent color visual system (i.e., sunlight is neither red nor green, and neither blue nor yellow). The EE illuminant represents a ‘white point’ in the CIE 1931 color space diagram, which is shown in FIG. 1B. As opposed to visual exposure to EE illumination like sunlight, it was recently described that excessive stimulation of L cones relative to M cones can lead to asymmetric growth in a developing human eye, leading to myopia (see, for example, patent application WO 2012/145672 A1). This has significant implications for electronic displays, which are conventionally optimized to display images with deeply saturated colors, including reds, and high contrast. It is believed that the myopiagenic effect of displays may be reduced by reducing the saturation of red-hued pixels in an image or reducing the relative amount of red to green in a pixel's color, particularly in those pixels where the amount of red exceeds the amount of green.

Analyzing and modifying image data to reduce the myopiagenic effect of displayed images can be a computationally demanding task, particularly when displaying images at high frame rates (e.g., 30 Hz or more). However, such functions can be efficiently implemented when rendering graphics in systems utilizing GPU's, such as mobile devices, video game consoles, and gaming computers. For example, shaders (i.e. fragment shaders) can be employed to reducing saturation of red-hued pixels in fragments during the rendering process itself.

In general, in a first aspect, the invention features methods for rendering graphics using a graphics processing unit (GPU), the methods including the following steps: (i) receiving, by a fragment shader executed on the GPU, rasterized data of a fragment of an image frame; (ii) determining, by the fragment shader executed on the GPU, an initial color for each pixel of the fragment, the initial color having a value, for a first sub-pixel color, a value, gⁱ, for a second sub-pixel color, and a value, bⁱ, for a third sub-pixel color; (iii) computing, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color; (iv) computing, by the fragment shader executed on the GPU, a myopia-corrected color for each pixel of the fragment having a relative level of stimulation exceeding a threshold level, the myopia-corrected color for each pixel having a value, r^{m}, for the first sub-pixel color and a value, g^{m}, for the second sub-pixel color for the pixel, wherein r^{m}≠rⁱ and/or g^{m}≠gⁱ; and (v) outputting, from the fragment shader executed on the GPU, the myopia-corrected pixel data for the fragment, the myopia-corrected pixel data including the myopia-corrected color for each pixel of the fragment having a relative level of stimulation exceeding the threshold level.

In general, in another aspect, the invention features a system, including a graphics processing unit (GPU) and a memory storing instructions that when executed cause the GPU to: (i) receive, by a fragment shader executed on the GPU, rasterized data of a fragment of an image frame; (ii) determine, by the fragment shader executed on the GPU, an initial color for each pixel of the fragment, the initial color having a value, rⁱ, for a first sub-pixel color, a value, gⁱ, for a second sub-pixel color, and a value, bⁱ, for a third sub-pixel color; (iii) compute, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color; (iv) compute, by the fragment shader executed on the GPU, a myopia-corrected color for each pixel of the fragment having a relative level of stimulation exceeding a threshold level, the myopia-corrected color for each pixel having a value, r^{m}, for the first sub-pixel color and a value, g^{m}, for the second sub-pixel color for the pixel, wherein r^{m}≠rⁱ and/or g^{m}≠gⁱ; and (v) output, from the fragment shader executed on the GPU, the myopia-corrected pixel data for the fragment, the myopia-corrected pixel data including the myopia-corrected color for each pixel of the fragment having a relative level of stimulation exceeding the threshold level.

In general, in a further aspect, the invention features a non-transitory computer readable medium storing a program causing a graphics processing unit (GPU) to execute a process including: (i) receiving, by a fragment shader executed on the GPU, rasterized data of a fragment of an image frame; (ii) determining, by the fragment shader executed on the GPU, an initial color for each pixel of the fragment, the initial color having a value, rⁱ, for a first sub-pixel color, a value, gⁱ, for a second sub-pixel color, and a value, bⁱ, for a third sub-pixel color; (iii) computing, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color; (iv) computing, by the fragment shader executed on the GPU, a myopia-corrected color for each pixel of the fragment having a relative level of stimulation exceeding a threshold level, the myopia-corrected color for each pixel having a value, r^{m}, for the first sub-pixel color and a value, g^{m}, for the second sub-pixel color for the pixel, wherein r^{m}≠rⁱ and/or g^{m}≠gⁱ; and (v) outputting, from the fragment shader executed on the GPU, the myopia-corrected pixel data for the fragment, the myopia-corrected pixel data including the myopia-corrected color for each pixel of the fragment having a relative level of stimulation exceeding the threshold level.

Implementations of any of the above aspects can include one or more of the following features. For example, the myopia-corrected color for each pixel can include a value, b^{m}, for the third sub-pixel color, wherein b^{m}≠bⁱ.

The relative level of stimulation can be computed by comparing rⁱ to gⁱ, where rⁱ is a magnitude of a red component and gⁱ is a magnitude of a green component of each pixel's initial color. The relative level of stimulation can exceed the threshold for a pixel where rⁱ is greater than gⁱ. In some embodiments, r^{m} is a magnitude of the red component and g^{m} is a magnitude of the green component of the myopia-corrected color for each pixel and either r^{m}<rⁱ and/or g^{m}>gⁱ.

The implementation can further comprising displaying rendered graphics on an electronic display based on the output myopia-corrected pixel data. When viewed on the electronic display, the graphics rendered using the myopia-corrected pixel data can have reduced contrast between neighboring cones in a viewer's eye compared to images rendered using the initial color for each pixel.

The GPU can generate myopia-corrected pixel data for multiple fragments in parallel.

The algorithms disclosed can be provided to developers of software as options in an API. Developers can provide adjustment options within the software itself to allow an end user to adjust the amount of myopia reduction provided, e.g., by providing multiple different shaders and/or the ability to modify a shader to provide different degrees of red reduction in rendered images.

Among other advantages, implementations can display rendered graphics with myopia-corrected images without any lag. The techniques can be implemented using existing hardware, e.g., by providing modifications to software alone.

Generally, the algorithms can be applied across a variety of different types of display including direct view displays, projection displays, and head mounted display. Applicable display technologies include liquid crystal displays, digital micro-mirror displays, organic light emitting diode displays, quantum dot displays, and cathode ray tube displays.

### BRIEF DESCRIPTION OF THE DRAWINGS

FIG. 1A shows an example of cone mosaic on a retina.

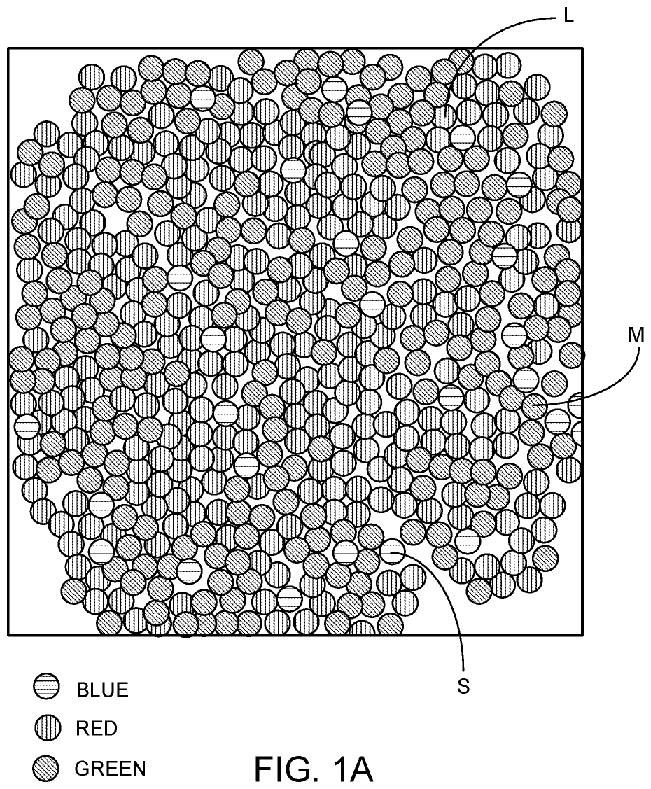

FIG. 1B is CIE 1931 chromaticity diagram showing equal energy illuminant points CIE-E, CIE-D65, and CIE-C.

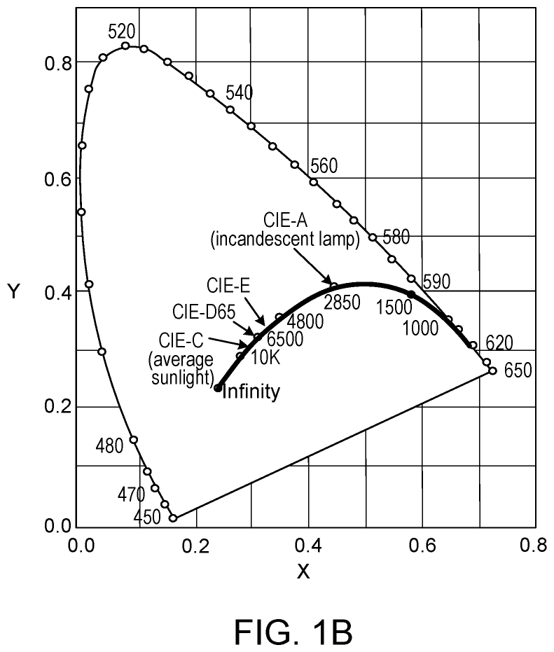

FIG. 2A is a block diagram illustrating an exemplary computing device that includes a graphics processing unit (GPU).

FIG. 2B is a flow chart illustrating an example of a graphics pipeline in a GPU.

FIGS. 3A and 3B show side cross-sections of a myopic eye and a normal eye, respectively.

### DETAILED DESCRIPTION

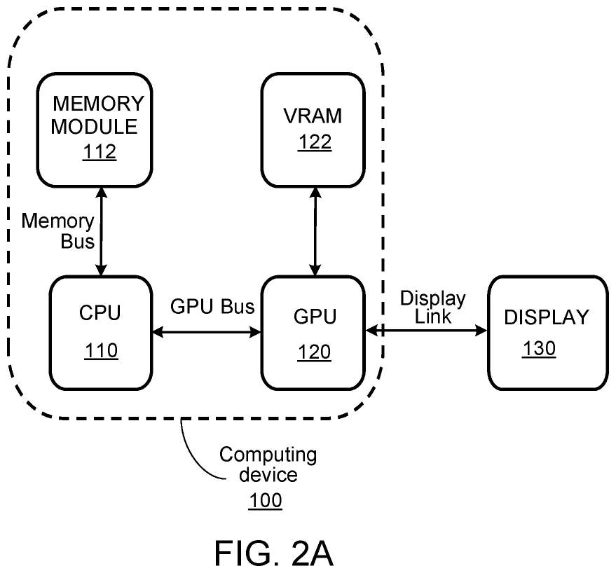

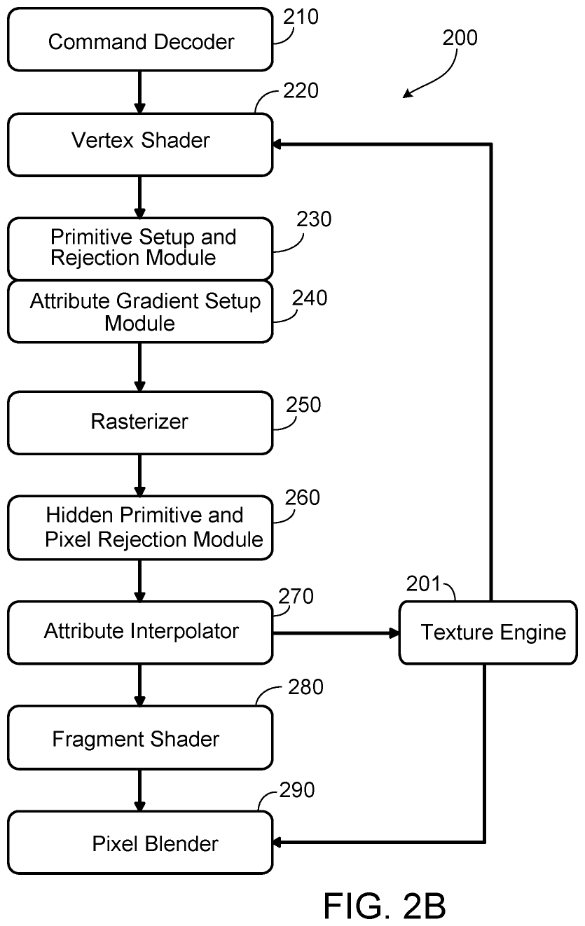

Referring to FIG. 2A, an exemplary computing device 100 includes central processing unit (CPU) 110 and a graphics processing unit (GPU) 120 which renders graphics for display on electronic display 130. Computing device 100 also includes a first memory module 112, e.g., a random access memory (RAM) memory module in communication with CPU 110 via a memory bus and a Video RAM module 122 in communication with GPU 120. CPU 110 and GPU 120 communicate via a GPU bus, which may be any type of bus or device interconnect. CPU 110 can be a general purpose or a special purpose microprocessor. For example, CPU 110 can be a commercially-available processor, e.g., from Intel Corporation of Santa Clara, Calif. or another type of microprocessor. GPU 120 is a dedicated graphics rendering device. GPU 120 can be integrated into a motherboard of computing device 100, can be present on a graphics card that is installed in a port in the motherboard of computing device 100, or can be otherwise configured to interoperate with computing device 100, for example.

Display 130, which is coupled to computing device 100 via a link (e.g., an HDMI link), can be a television, a projection display, a liquid crystal display, a plasma display panel, a light emitting diode (LED) array, an organic LED (OLED) display, a micro-LED display, a cathode ray tube display, a surface-conduction electron-emitted display (SED), a laser television display, a nanocrystal display, or another type of display unit, for example. Display 130 can be integrated into of computing device 100. For instance, display 100 can be a screen of a mobile device, such as a smart phone or tablet computer. Alternatively, display 130 can be external to computer device 100 and can be in communication with computing device 100 via a wired or wireless communications connection or other connection, for example.

Generally, computing device 100 can be a personal computer, a desktop computer, a laptop computer, a workstation, a video game platform or console, a cellular or satellite radiotelephone, a landline telephone, an Internet telephone, a handheld device such as a portable video game device or a personal digital assistant, a personal music player, a server, an intermediate network device, a mainframe computer, or another type of device that outputs graphical information.

CPU 110 is used to execute various software applications, such as video games, graphical user interface engines, computer-aided design programs for engineering or artistic applications, or another type of software application that uses two-dimensional (2D) or three-dimensional (3D) graphics, by way of example. When CPU 110 executes the software application, the software application can invoke subroutines of a graphics processing application programming interface (API), such as any one or more of an OpenVG API, an OpenGL API, a Direct3D API, a Graphics Device Interface (GDI), Quartz, QuickDraw, or another type of 2D or 3D graphics processing API, by way of example.

When a software application invokes a subroutine of the graphics processing API, the graphics processing API invokes one or more subroutines of a GPU driver. The GPU driver can include a set of software and/or firmware instructions that provide an interface between the graphics processing API and GPU 120, for example. When the graphics processing API invokes a subroutine of the GPU driver, the GPU driver formulates and issues a command that causes GPU 120 to generate displayable graphics information. For example, when the graphics processing API invokes a subroutine of the GPU driver to render a batch of graphics primitives, the GPU driver provides GPU 120 with a processing configuration, which GPU 120 uses to render the batch of graphics primitives. GPU 120 renders the batch of graphics primitives, and outputs a raster image of the graphics primitives, for example.

Generally, GPU 120 renders multiple image fragments in parallel using multiple graphics pipelines. Referring to FIG. 2B, an example of a graphics pipeline 200 of GPU 120 includes a command decoder 210. Command decoder 210 decodes commands from the GPU driver and configures processing elements of GPU 120 to perform the command. For example, command decoder 210 can retrieve graphics processing configuration(s) from memory and load a set of instructions identified by the graphics processing configuration(s) into the processing element which implements the graphics pipeline.

Graphics pipeline 200 also includes a vertex shader 220 and a fragment shader 280, plus other stages, which includes, in this example, a texture engine 201, a primitive setup and rejection module 230, an attribute gradient setup module 240, a rasterizer 250, a hidden primitive and rejection module 260, an attribute interpolator 270, and a pixel blender 290. Vertex shader 210 determines surface properties of an image to be rendered at vertices within the image. In this way, vertex shader 210 generates vertex coordinates and attributes of each of the vertices within the image geometry. The vertex coordinates identify the vertices within the image geometry based on, for example, a four-dimensional coordinate system with X, Y, and Z (width, height, and depth) coordinates that identify a location of a vertex within the image geometry, and a W coordinate that comprises a perspective parameter for the image geometry. The vertex attributes, for example, may include color, normal, and texture coordinates associated with a vertex. Vertex shader 210 within GPU 120 makes the attributes and/or coordinates for vertices processed by vertex shader 210 to other stages of the pipeline 200.

Primitive setup and rejection module 230, attribute gradient setup module 240, rasterizer 250, hidden primitive and pixel rejection module 260, and attribute interpolator 270, each use either vertex coordinates or vertex attributes to process the image geometry. Primitive setup and rejection module 230 assembles primitives with one or more vertices within the image geometry, applies perspective projection and viewport transformations on primitive vertices and determines edge coefficients for each primitive edge. In addition, primitive setup and rejection module 230 can examine a primitive to determine whether or not to reject the primitive.

Attribute gradient setup module 240 computes gradients of attributes associated with the primitives for the image geometry. Attribute gradient setup module 240 also uses vertex attributes to compute the attribute gradients.

Once the attribute gradient values are computed, rasterizer 250 converts the primitives for the image geometry into pixels based on the XY coordinates of each of the vertices within the primitives and the number of pixels included in the primitives. Hidden primitive and pixel rejection module 260 rejects hidden primitives and hidden pixels within the primitives.

Attribute interpolator 270 interpolates attributes associated with the primitives for the image geometry over pixels within the primitives based on attribute gradient values. Fragment shader threads are packed at the end of processing by attribute interpolator 270 and communicated to a shader unit. Attribute interpolator 270 can disregard attributes of vertices associated with rejected primitives within the image geometry. Interpolated attribute values become input to pixel blender 290, bypassing fragment shader 280. Results of pixel blender 290 can be output for presentation of the processed image using an output device, such as display 130.

As illustrated in the example of FIG. 2B, output from the vertex shader 220, e.g., texture data generated by vertex shader 220, can output to the texture engine 201, for use in subsequent processing by graphics pipeline 200. In addition, vertex shader 220 can submit a texture data lookup request to texture engine 201, to retrieve texture data for use with vertex shader 220.

In a case that fragment shader 280 is performed in graphics pipeline 200 (e.g., it is not bypassed), attribute interpolator 270, forwards its output, e.g., pixel attribute/color data, to fragment shader 280. In addition, attribute interpolator 270 submits a request for initial textures to texture engine 201. In response, texture engine 201 obtains the requested textures and forwards them for use by fragment shader 280.

Alternatively, in a case that fragment shader 280 is bypassed and some minimal fragment shading is to be performed, a request for initial textures is submitted to texture engine 201 from attribute interpolator 270. In response, texture engine 201 forwards the requested textures to pixel blender 290, which uses the texture data in the fragment shading operations performed by pixel blender 290.

Fragment shader 280 includes instructions that cause the GPU to render graphics such that each pixel in a fragment is assigned a value for a red component, a green component, and a blue component so that the corresponding image displayed, e.g., using display 130 produces either (i) a reduced level of differential stimulation between L cones and M cones in a viewer's eye and/or (ii) a reduced level of differential stimulation between neighboring cones, compared with viewing an image produced using subroutines that do not include myopia correction. The GPU achieves this by outputting pixel data that includes, for at least some image fragments, a myopia-corrected value for red, r^{m}, a myopia-corrected value for green, g^{m}, and a myopia-corrected value for blue, b^{m}, based on at least respective initial values rⁱ, gⁱ, and bⁱ for the corresponding pixel in the corresponding fragment rendered conventionally. In order to provide reduced myopiagenia in the displayed image, for certain pixels either r^{m}≠rⁱ, g^{m}≠gⁱ, and/or b^{m}≠bⁱ. Exemplary algorithms for fragment shaders for generating myopia-corrected pixel data are described below.

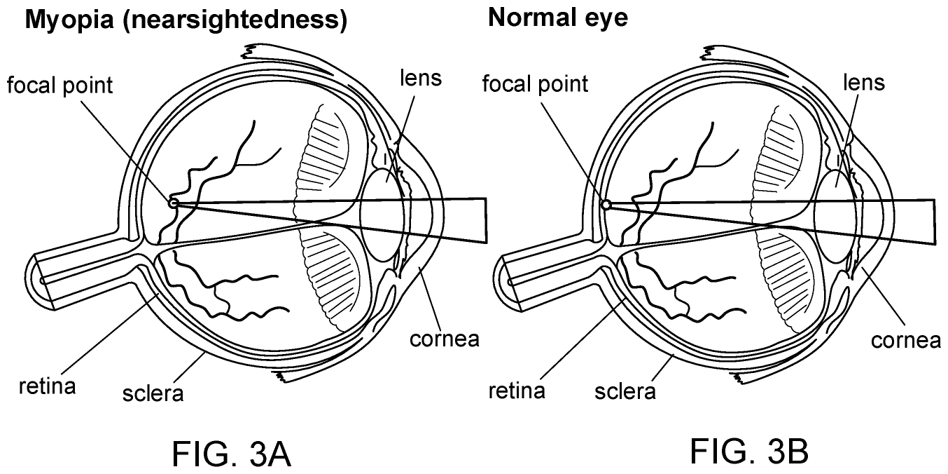

Before discussing algorithms, it is instructive to consider the cause of the myopiagenic effect of electronic displays. Myopia—or nearsightedness—is a refractive effect of the eye in which light entering the eye produces image focus in front of the retina, as shown in FIG. 3A for a myopic eye, rather than on the retina itself, as shown in FIG. 3B for a normal eye. Without wishing to be bound by theory, it is believed that television, reading, indoor lighting, video games, and computer monitors all cause progression of myopia, particularly in children, because those displays produce stimuli that cause uneven excitation of L and M cones (for example stimulating L cones more than M cones) and/or uneven excitation of neighboring cones in the retina. During childhood (approximately age 8), adolescence (before age 18), and young adulthood (until age 25 years or age 30 years), these factors of differential stimulation result in abnormal elongation of the eye, which consequently prevents images from be focused on the retina.

There are two factors in an image that can result in a high degree of retinal cone contrast: one spatial and one chromatic. The spatial factor refers to the degree to which an image contains high spatial frequency, high contrast features. Fine contrast or detail, such as black text on a white page, form a high contrast stimulation pattern on the retinal cone mosaic. The chromatic factor refers to how uniform blocks of highly saturated colors stimulate cone types asymmetrically, and therefore form a high contrast pattern on the retina. For example, red stimulates L cones more than M cones, whereas green light stimulates M cones more than L cones. Shorter wavelength light, such as blue, stimulates S cones more than either L or M cones. The degree of color can refer to either the number of pixels of that color as well as their saturation levels, or both. Here, for example, red pixels may be identified as pixels for which r is greater than g and/or b by a threshold amount or a percentage amount. Alternatively, or additionally, red pixels may be identified as pixels that have a red hue in the 1931 or 1976 CIE color space. Similarly, green pixels could be identified as pixels for which g is greater than r and/or b by a threshold or percentage amount; or green pixels may be identified as pixels that have a green hue in the 1931 or 1976 CIE color space. Similarly, blue pixels could be identified as pixels for which b is greater than r or g by a threshold amount or a percentage amount; or blue pixels could be identified as pixels that have a blue hue in the 1931 and 1976 CIE color space.

Referring back to the operation of fragment shader 280 in FIG. 2B, the fragment shader assigns each pixel in a fragment with initial component color values based on the attribute/color data from attribute interpolator 270. Accordingly, for RGB colors, each initial pixel data is composed of three color component values, rⁱ, gⁱ, and bⁱ, corresponding to values for red, green, and blue, respectively.

For myopia correction, shader 280 includes a subroutine that determines a relative level of stimulation of L cones, M cones, and/or S cones, for each pixel in the fragment based on the values rⁱ, gⁱ, and bⁱ. For example, this step may simply involve comparing the value of rⁱ to the value of gⁱ and/or bⁱ for a pixel. Alternatively, or additionally, XYZ tristimulus values, LMS values, or other ways to measure cone stimulation may be calculated, by the electronic processing module, from the RGB values.

Next, one or more pixels are identified, by the shader, for color modification based on the relative level of L, M, and/or S cone stimulation by each pixel. For example, in some embodiments, red pixels are identified by comparing the RGB values or based on a hue of each pixel. In other embodiments, pixels are chosen because of high levels of color contrast with other neighboring pixels. In still other embodiments, pixels are chosen because of high differences in cone stimulation levels among neighboring cones.

In some embodiments, pixels are identified based on the color of other pixels in the fragment. For example, groups of adjacent red pixels (e.g., corresponding to red objects in an image) are identified for modification but lone red pixels are left unmodified.

Next, shader 280 generates myopia-corrected image data, based on the relative level of stimulation of L cones to M cones, or the level of adjacent cone contrast, and, in some cases, other factors (e.g., user preferences and/or aesthetic factors). A variety of modification functions may be used. In general, the modification will reduce the level of red saturation in a pixel's color and/or reduce the contrast level between adjacent pixels or adjacent groups of pixels.

In some embodiments, for those pixels identified for color modification, modified image data is generated by scaling rⁱ, gⁱ, and/or bⁱ, e.g., by a corresponding scale factor α, β, γ, defined below in EQ. (1).

In other words:

r^{m}=αrⁱ,

g^{m}=βgⁱ, and/or

b^{m}=γbⁱ. (1)

In general, the scale factors α, β, and/or γ for each pixel may vary depending on a variety of factors, such as, for example rⁱ, gⁱ, and/or bⁱ for that pixel, rⁱ, gⁱ, and/or bⁱ of another pixel in the same fragment, and/or other factors.

For example, in some embodiments, where rⁱ>gⁱ and rⁱ>bⁱ in a pixel, rⁱ may be decreased for that pixel by some amount (i.e., 0<α<1) and/or gⁱ may be increased for that pixel by some fractional amount (i.e., 1<β). bⁱ may be unchanged (i.e., γ=1), or can be increased or decreased. In certain implementations, α and/or β are functions of the difference between rⁱ and gⁱ. For instance, scale factors can be established so that the larger the difference between rⁱ and gⁱ, the more the red value in the modified signal is reduced relative to the initial signal and/or the more the green value in the modified signal is increased. By way of example, one simple mathematical formulation for this type of scale is:

α=k_{α}(rⁱ−gⁱ)+c_{α}, and

β=k_{β}(rⁱ−gⁱ)+c_{α}. (2)

In EQ. (2), k_{α} and k_{β} are proportionality constants and c_{α} and c_{β} are constant offsets. k_{α} is negative so that a larger difference between rⁱ and gⁱ results in a smaller value for α. Conversely, k_{β} is positive so that β increases proportionally to the difference between rⁱ and gⁱ. The proportionality constants and constant offsets may be determined empirically.

Generally, in implementations where 0<α<1 and β=γ=1, red pixels in the modified image will appear darker than in the initial image. In implementations where α=γ=1 and 1<β, red pixels in the modified image will appear lighter than in the initial image. In both cases, the degree of red saturation in the red pixels will decrease as the amount of red decreases relative to green.

In yet another embodiment, matrix multipliers may be used that create a linear transformation, e.g., as in EQ. (3):

$$[ \begin{matrix}{r}^{m} \\ {ℊ}^{m} \\ {b}^{m}\end{matrix} ] = [ \begin{matrix}α \\ β \\ γ\end{matrix} ] [ \begin{matrix}{r}^{i} & {ℊ}^{i} & {b}^{i} \\ {r}^{i} & {ℊ}^{i} & {b}^{i} \\ {r}^{i} & {ℊ}^{i} & {b}^{i}\end{matrix} ] . \qquad ( 3 )$$

In some embodiments, values for r^{m}, g^{m}, and b^{m} are derived from linear combinations of their corresponding initial values and the difference between r and g. To illustrate an example that is not meant to bound the invention, e.g., as in EQ. (4):

r^{m}=rⁱ+α(rⁱ−gⁱ)

g^{m}=gⁱ+β(rⁱ−gⁱ)

b^{m}=bⁱ+γ(rⁱ−gⁱ). (4)

In some embodiments of EQ. (4), −1<α<0 and β and γ are both values between 0 and 1. More specifically, where β=γ=−α/2, the transformation given in terms of EQ. (4) results in a final pixel that is equiluminant to the initial pixel. The condition of equiluminance is satisfied when (r^{m}+g^{m}+b^{m})=(rⁱ+gⁱ+bⁱ).

While the modification of each component color described above is proportional to the input component color value, non-linear scaling is also possible (e.g., involving more than one scale factor and one or more additional higher order terms in the input component color value).

Finally, shader 280 outputs the myopia-corrected pixel data for the fragment.

The graphics pipeline described above is exemplary. Algorithms for myopia correction can be included in fragment shaders in other graphics pipelines. Furthermore, the disclosed techniques can be applied to any type of GPU, including commercially-available GPU's and custom made GPU's.

Furthermore, while the foregoing algorithms refer to RGB color components, other similar algorithms can be applied to other component colors (e.g., CYM).

In some embodiments, different fragment shaders are provided as part of an API for software developers to include in the software applications they code. For example, fragment shaders that use different algorithms (e.g., different degrees of red saturation reduction) for myopia correction can be included. Accordingly, developers can provide users of their software applications with options to utilize different degrees of myopia correction, e.g., in the user settings of the software application.

### Example

A fragment shader in the Unity game engine (https://unity3d.com/) was augmented to include a subroutine that included a myopia correction for each pixel.

The algorithm implemented using the subroutine set a scaling factor, p, to 0.5 and a threshold value, t, to 0. In general, other values for these parameters are possible.

For each input value for red (rⁱ), green (gⁱ), and blue (^{bi}), the algorithm calculated a difference value, d=rⁱ−gⁱ.

If d>t, then the algorithm established myopia corrected values for red (r^{m}), green (g^{m}), and blue (b^{m}) as follows:

r^{m}=rⁱ−(p×d)

r^{m}=gⁱ+(p×d)/2

b^{m}=g^{m}+(p×d)/4

The algorithm returns r^{m}, g^{m}, b^{m}, if corrected, or else returns rⁱ, gⁱ, bⁱ.

The sub-routine produced a noticeable color correction without any perceivable lag when run on an iPhone 5S and an iPhone XS running iOS 12.

Other embodiments are in the following claims.

What is claimed is:

1. A method for rendering graphics using a graphics processing unit (GPU), the method comprising:
receiving, by a fragment shader executed on the GPU, rasterized data of a fragment of an image frame;
determining, by the fragment shader executed on the GPU, an initial color for each pixel of the fragment, the initial color comprising a value, rⁱ, for a first sub-pixel color, a value, gⁱ, for a second sub-pixel color, and a value, bⁱ, for a third sub-pixel color;
computing, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color;
computing, by the fragment shader executed on the GPU, a myopia-corrected color for each pixel of the fragment having a relative level of stimulation exceeding a threshold level, the myopia-corrected color for each pixel comprising a value, r^{m}, for the first sub-pixel color and a value, g^{m}, for the second sub-pixel color for the pixel, wherein r^{m}≠rⁱ and/or g^{m}≠gⁱ; and
outputting, from the fragment shader executed on the GPU, the myopia-corrected pixel data for the fragment, the myopia-corrected pixel data comprising the myopia-corrected color for each pixel of the fragment having a relative level of stimulation exceeding the threshold level.

2. The method of claim 1, wherein the myopia-corrected color for each pixel comprises a value, b^{m}, for the third sub-pixel color, wherein b^{m}≠bⁱ.

3. The method of claim 1, wherein the relative level of stimulation is computed by comparing rⁱ to gⁱ, where rⁱ is a magnitude of a red component and gⁱ is a magnitude of a green component of each pixel's initial color.

4. The method of claim 3, wherein the relative level of stimulation exceeds the threshold for a pixel where rⁱ is greater than gⁱ.

5. The method of claim 4, wherein r^{m} is a magnitude of the red component and g^{m} is a magnitude of the green component of the myopia-corrected color for each pixel and either r^{m}<rⁱ and/or g^{m}>gⁱ.

6. The method of claim 1, further comprising displaying rendered graphics on an electronic display based on the output myopia-corrected pixel data.

7. The method of claim 6, wherein when viewed on the electronic display, the graphics rendered using the myopia-corrected pixel data have reduced contrast between neighboring cones in a viewer's eye compared to images rendered using the initial color for each pixel.

8. The method of claim 1, wherein the GPU generates myopia-corrected pixel data for multiple fragments in parallel.

9. A system, comprising:
a graphics processing unit (GPU) and a memory storing instructions that when executed cause the GPU to:
receive, by a fragment shader executed on the GPU, rasterized data of a fragment of an image frame;
determine, by the fragment shader executed on the GPU, an initial color for each pixel of the fragment, the initial color comprising a value, rⁱ, for a first sub-pixel color, a value, gⁱ, for a second sub-pixel color, and a value, bⁱ, for a third sub-pixel color;
compute, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color;
compute, by the fragment shader executed on the GPU, a myopia-corrected color for each pixel of the fragment having a relative level of stimulation exceeding a threshold level, the myopia-corrected color for each pixel comprising a value, r^{m}, for the first sub-pixel color and a value, g^{m}, for the second sub-pixel color for the pixel, wherein r^{m}≠rⁱ and/or g^{m}≠gⁱ; and
output, from the fragment shader executed on the GPU, the myopia-corrected pixel data for the fragment, the myopia-corrected pixel data comprising the myopia-corrected color for each pixel of the fragment having a relative level of stimulation exceeding the threshold level.

10. A non-transitory computer readable medium storing a program causing a graphics processing unit (GPU) to execute a process comprising:
receiving, by a fragment shader executed on the GPU, rasterized data of a fragment of an image frame;
determining, by the fragment shader executed on the GPU, an initial color for each pixel of the fragment, the initial color comprising a value, rⁱ for a first sub-pixel color, a value, gⁱ, for a second sub-pixel color, and a value, bⁱ, for a third sub-pixel color;
computing, by the fragment shader executed on the GPU, a relative level of stimulation of cones in a viewer's eye for each pixel of the fragment based, at least, on the value, rⁱ, for the first sub-pixel color and the value, gⁱ, for the second sub-pixel color;
computing, by the fragment shader executed on the GPU, a myopia-corrected color for each pixel of the fragment having a relative level of stimulation exceeding a threshold level, the myopia-corrected color for each pixel comprising a value, r^{m}, for the first sub-pixel color and a value, g^{m}, for the second sub-pixel color for the pixel, wherein r^{m}≠rⁱ and/or g^{m}≠gⁱ; and
outputting, from the fragment shader executed on the GPU, the myopia-corrected pixel data for the fragment, the myopia-corrected pixel data comprising the myopia-corrected color for each pixel of the fragment having a relative level of stimulation exceeding the threshold level.
